(19) United States
(12) Patent Application Publication
(10) Pub. No.: US 2015/0156653 A1
(43) Pub. Date: Jun. 4, 2015

(54) PACKET ANALYSIS WITHIN A RADIO ACCESS NETWORK

(71) Applicant: TELEFONAKTIEBOLAGET L M ERICSSON (PUBL), Stockholm (SE)

(72) Inventors: Fredrik Persson, Marsta (SE); Hans Eriksson, Sollentuna (SE); Jens Knutsson, Enebyberg (SE); Paul Stjernholm, Lidingo (SE); Lars Westberg, Enkoping (SE)

(21) Appl. No.: 14/407,432

(22) PCT Filed: Jun. 11, 2013
(86) PCT No.: PCT/EP2013/062061

§ 371 Date: Dec. 11, 2014

Related U.S. Application Data
(60) Provisional application No. 61/658,705, filed on Jun. 12, 2012.

(51) Int. Cl. H04W 24/08; H04W 4/18; H04L 12/26; H04L 29/06; H04L 29/08

(52) U.S. Cl. CPC H04W 24/08; H04L 69/04; H04L 67/2828; H04L 43/026; H04W 4/18

(57) ABSTRACT

A method of handling user plane data in a packet switched network. A packet inspection node determines a compression ratio and/or content information for the user plane data, and sends said compression ratio and/or content information towards a user plane data handling node. The user plane data handling node receives the compression ratio and/or content information, and handles the user plane data in dependence upon the compression ratio and/or content information.

### BACKGROUND

In mobile networks, data compression is often used to reduce the bandwidth required for data transfer. Data compression solutions are often implemented between end points which lie outside the radio access network (RAN). For example, data may be compressed at a user equipment sending a data stream, and decompressed at the receiving user equipment. This compression prevents nodes in the RAN from accurately measuring and analysing data flows in the network. The compressed packets may have variable compression rates, and so the actual data transferred to the receiver cannot be accurately estimated from monitoring the compressed packets alone. Furthermore, the compression obscures the content of the packets, and makes it impossible for the RAN to determine what type of services are being delivered, e.g. to employ traffic shaping.

One example of data compression is de-duplication, which is based on shortening repeated data patterns in a data stream. An example method of de-duplication is as follows:
1. The compressor identifies a repeated data pattern (denoted Gi) in the data stream.
2. The compressor replaces each occurrence of Gi with a pointer Ni. The pointer is a reference to the pattern Gi in a compression table (also referred to as a “code book” or state table).
3. The compressor repeats steps 1 and 2 for each repeated data pattern.
4. The compressor sends the data stream to the decompressor with each Gi replaced by the corresponding Ni. The compressor also sends the compression table (or any changes to the compression table) to the decompressor.
5. The decompressor receives the data stream, and replaces each occurrence of a pointer Ni by the corresponding Gi.
6. The data stream is then read by the receiver.

This method is roughly illustrated in FIG. 1. More advanced compression technology may include transformations to increase the probability that a duplicate can be found for a given sequence. Advanced compression technologies include header compression, e.g. Robust Header Compression (RoHC).

In practical applications, the compressor will not act on the entire media stream at once. Instead, the compressor will continually compress the stream as it is transmitted, identifying and compressing repeated data patterns as it goes along. This allows the stream to be transmitted in real time. However, when the compressor is first initialised, it must “learn” the repeated patterns for the data that flows through it, and so the compression algorithm takes significant time to converge (i.e. approach maximum efficiency). These solutions are normally executed on the network user plane, and do not rely on the control plane.

To ensure a good end-user experience, it is important for the network to be able to monitor the data traffic, and use the results of the monitoring to make Radio Resource Management (RRM) decisions. Systems in the RAN constantly perform measurements on the data passing through the RAN, which can be used for external analysis, or internal decision making. The radio network implements a number of RRM algorithms, which are used to control end-user performance. For example, in order for a packet data scheduler to make good decisions, it must have correct information about the quality of service (e.g. bit rate, packet loss, etc.) that the users in the cell are experiencing.

The radio network also includes a large number of monitoring nodes. These are used to measure end-user performance, and the results are used to understand the overall performance of the network and identify potential improvements.

The RAN (including the RRM algorithms) can be made more efficient if it can determine the types of services and applications being used. For example, this knowledge may be used to prioritise certain “real time” services, such as streaming voice and video, compared to “non real time” services such as file downloads. This data can be collected by the use of packet inspection (PI). The term “packet inspection” is used herein for packet analysis at different levels, from simple monitoring the IP header classification, to deep packet inspection (DPI), which monitors the whole contents of the packet. A brief description of the levels of inspection and analysis is given below:

### IP Header Classification (A.K.A. 5-Tuple Inspection)

This method inspects a section of the packet known as the “5-tuple”, which comprises the data in the packet up the to internet layer. The 5-tuple consists of the source IP address, source port, destination IP address, destination port, and (transport layer) protocol.

IP header classification is used to discriminate between traffic from certain domains, e.g. the Internet, or virtual private networks (VPNs). One example may be to implement a certain QoS for Internet traffic. Another example may be to implement special security protocols for VPN traffic.

### Shallow Inspection

This method analyses the transport layer of the packet, by inspecting the protocol header (TCP, UDP etc.). For example, this could include analysis TCP header flags such a SYN, ACK, and FIN to monitor the state of the connection.

Shallow inspection is used to trigger link layer algorithms from sequences of higher layer protocol interaction, when the algorithms do not need to know what content is being carried by the packets. An example of such use to is decrease terminal battery consumption by allowing lower layer protocol states to follow higher later protocols.

### Deep Packet Inspection (DPI)

This method analyses the packet right down to the application layer (e.g. HTTP state, video content).

A common example of DPI use is caching, where the HTTP request is analysed to identify which content to fetch from the cache. Link layer algorithms may also make use of DPI to react to specific types of content or applications.

### Heuristic Detection

This method involves pattern detection or other statistical analysis methods on application layer data. This is typically used to classify services with encrypted content, or which otherwise try to avoid identification.

With the exception of heuristic detection, which is often unreliable, none of these methods will work consistently on compressed packets, and therefore the measurements made in the RAN will not reflect the performance experienced by the end user. One possible solution to the problem would be to decompress the data within the monitoring node, perform the measurements, recompress the data and then send it on to the destination. However, the increased latency, processor load, and expenditure which result from implementing such a system may make this unfeasible for financial or performance reasons.

### SUMMARY

According to an aspect of the present invention, there is provided an apparatus configured to operate as a packet inspection node. The apparatus comprises a data analysis processor and a sender. The data analysis processor is for determining a compression ratio and/or content information for user plane data. The sender is for sending the compression ratio and/or content information to a user plane data handling node.

According to a further aspect of the present invention, there is provided an apparatus configured to operate as a node in a radio access network. The apparatus comprises a content information receiver and a user plane data handling processor. The content information receiver is for receiving a compression ratio and/or content information associated with user plane data. The user plane data handling processor is for handing the user plane data in dependence upon the compression ratio and/or content information.

According to a yet further aspect of the present invention, there is provided an apparatus configured to act as a node (200) in a radio access network. The apparatus comprises a breakout handler, a decompressor, a performance measurement processor, and a user plane data handling processor. The breakout handler is for receiving user plane data, and copying said user plane data. The decompressor is for decompressing the copied user plane data. The performance measurement processor is for performing performance measurements on the decompressed copied user plane data. The user plane data handling processor is for handling the user plane data in dependence upon results of the performance measurements.

According to a yet further aspect of the present invention, there is provided an apparatus configured to act as a compressor in a packet switched network. The apparatus comprises a filtering processor and a compression processor. The filtering processor is configured to select packets of user plane data for compression in dependence upon a compression filter. The compression processor is configured to compress the selected packets.

According to a yet further aspect of the present invention, there is provided an apparatus configured to act as a node in a radio access network. The apparatus comprises a receiver, a filtering processor, a performance measurement processor, and a user plane data handling processor. The receiver is for receiving user plane data. The filtering processor is configured to select packets of the user plane data for analysis in dependence upon a filter. The performance measurement processor is for performing performance measurements on the selected packets of the user plane data. The user plane data handling processor is for handling the user plane data in dependence upon results of the performance measurements.

According to a yet further aspect of the present invention, there is provided a method of handling user plane data in a packet switched network. A packet inspection node determines a compression ratio and/or content information for the user plane data, and sends said compression ratio and/or content information towards a user plane data handling node. The user plane data handling node receives the compression ratio and/or content information, and handles the user plane data in dependence upon the compression ratio and/or content information.

According to a yet further aspect of the present invention, there is provided a method of handling user plane data in a packet switched network. A user plane data handling node receives the user plane data, makes a copy of the user plane data and decompresses the copied user plane data. The user plane data handling node then performs performance measurements on the decompressed copied user plane data and handles the user plane data in dependence upon results of the performance measurements.

According to a yet further aspect of the present invention, there is provided a method of handling user plane data in a packet switched network. A compressor selects packets of the user plane data for compression in dependence upon a compression filter, and sends said user plane data towards a receiving device. A user plane data handling node receives the user plane data and selects packets of the user plane data for analysis in dependence upon the compression filter. The user plane data handling node then performs performance measurements on the selected user plane data packets and handles the user plane data in dependence upon results of the performance measurements.

According to a yet further aspect of the present invention, there is provided a computer program comprising computer readable code which, when run on an apparatus, causes it to behave as an apparatus or perform a method according to any of the previous aspects. The computer program may be stored on a non-transitory computer readable medium.

### BRIEF DESCRIPTION OF THE DRAWINGS

FIG. 1 shows a method of compressing data;

FIG. 2 is a flowchart of a method according to a first solution;

FIG. 3 is a schematic illustration of a packet inspection node according to a first solution;

FIG. 4 is a schematic illustration of a user plane data handling node according to a first solution;

FIG. 5 shows an example of an informational element in a packet header;

FIG. 6 shows a system according to one alternative implementation of the first solution;

FIG. 7 shows a system according to a further alternative implementation of the first solution;

FIG. 8 shows a system according to a yet further alternative implementation of the first solution;

FIG. 9 shows a system according an implementation of a second solution;

FIG. 10 illustrates a user plane data handling node according to the second solution;

FIG. 11 is a flowchart of the method of the second solution;

FIG. 12 illustrates schematically a user plane data handling node according to the second solution;

FIG. 13 shows a system according to an implementation of a third solution;

FIG. 14 shows an alternative view of the system of FIG. 13;

FIG. 15 is a flowchart showing a filter update procedure according to the third solution;

FIG. 16 is a flowchart showing a method according to the third solution;

FIG. 17 illustrates schematically a compressor according to the third solution;

FIG. 18 illustrates schematically a user plane data handling node according to the third solution;

FIG. 19 is a flowchart further illustrating the method according to the third solution.

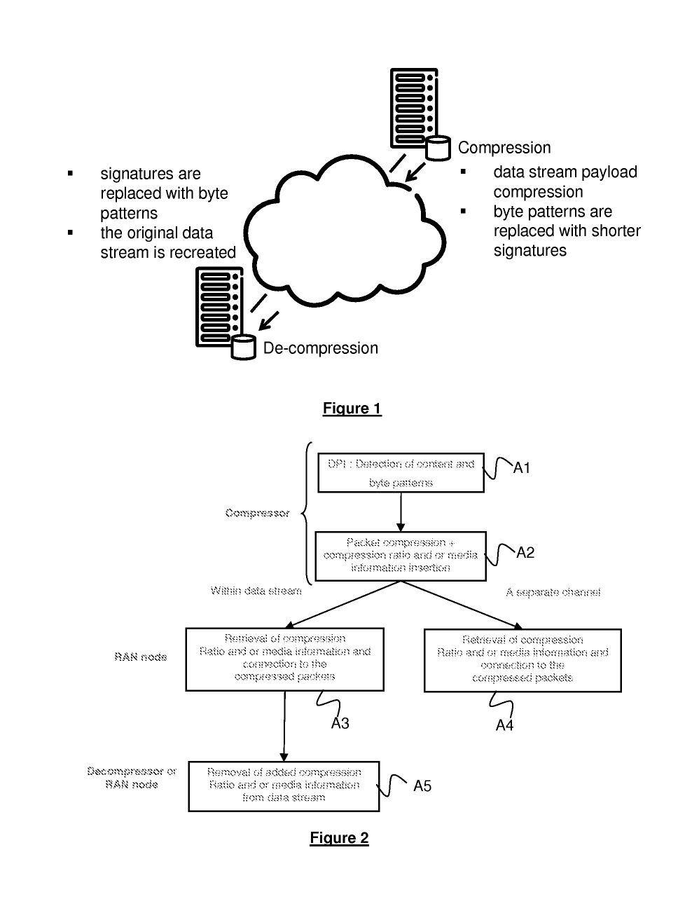

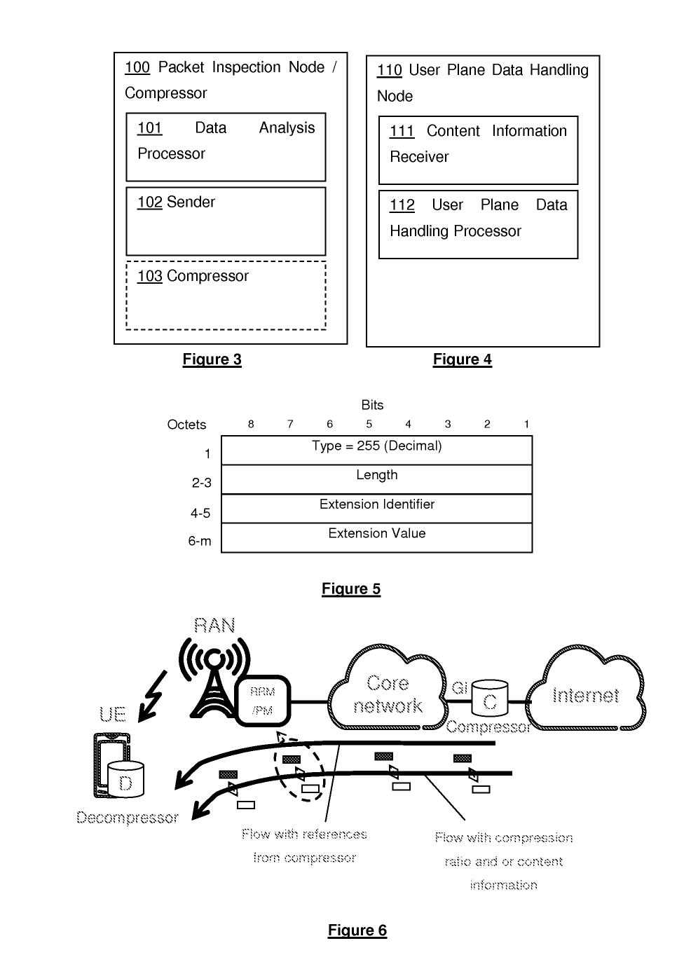

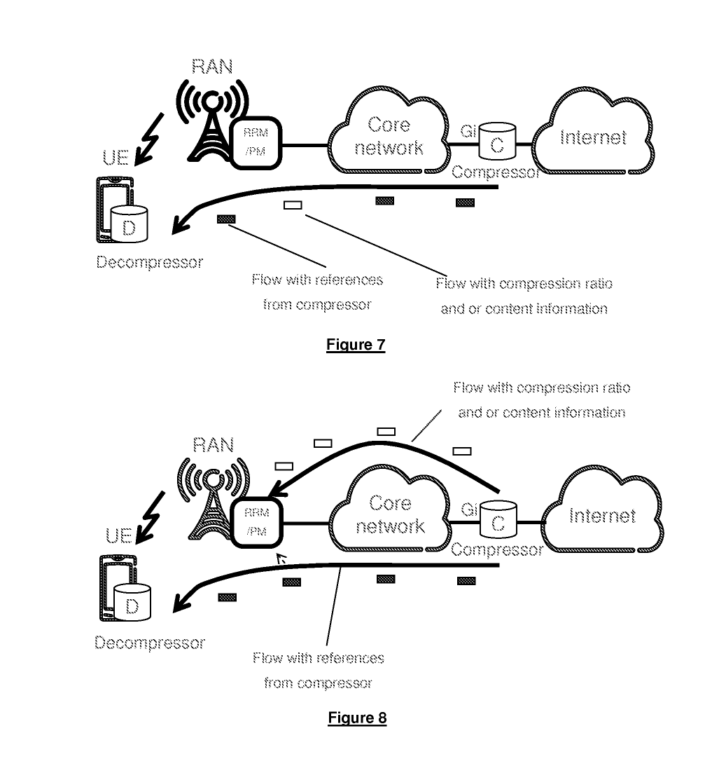

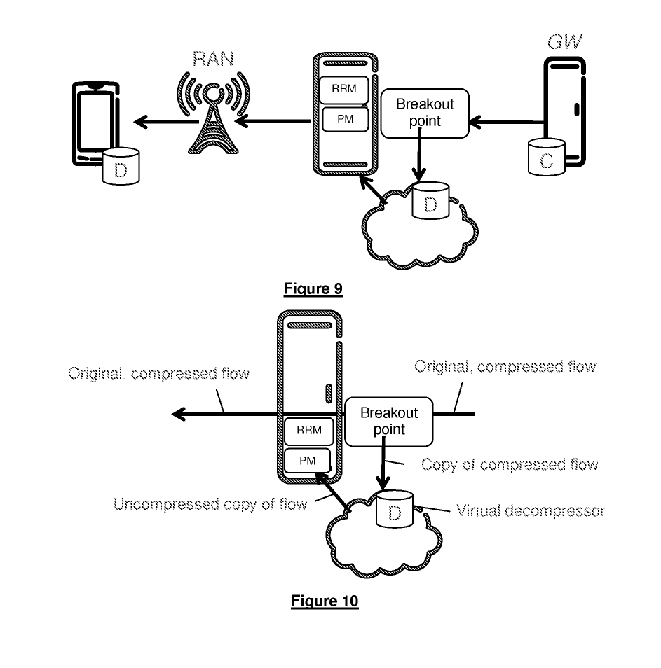

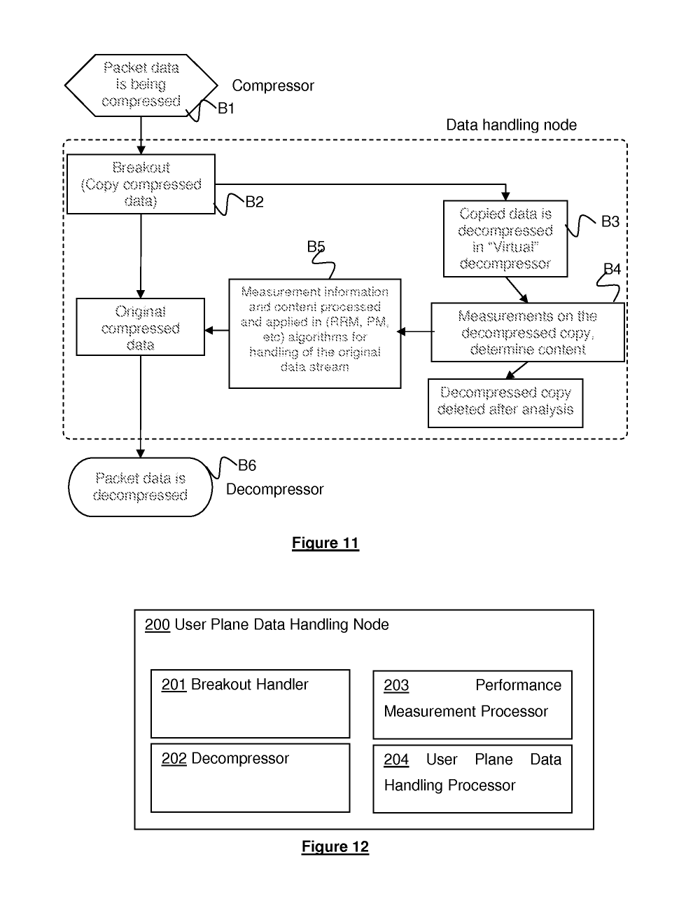

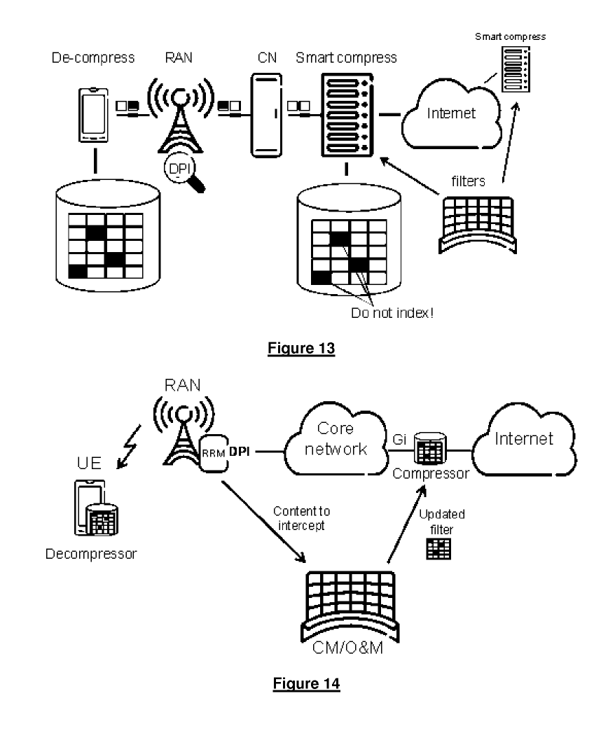

### DETAILED DESCRIPTION

A number of solutions to this problem will now be presented, with the following abbreviations being used:
DPI Deep Packet Inspection
MPTCP Multi Path Transmission Control Protocol
O&M Operations & Maintenance
RAN Radio Access Network
RNC Radio Network Controller
RRM Radio Resource Management
TCP Transmission Control Protocol
UDP User Datagram Protocol
UE User Equipment

A first solution involves including data about the compression ratio and/or content of the packets within the compressed data stream. A flowchart of the method of this solution is shown in FIG. 2, and apparatus for implementing the solution is illustrated in FIGS. 3 and 4. The compression ratio and/or content information is determined A1 by a data analysis processor 101 in the compressor, or in a node which handles the data prior to compression 100. This data is then sent A2 to the user plane data handling node(s) 110 in the RAN either together with the user plane data, or via a separate channel. The user plane data handling node 110 receives the compression ratio and/or content information A3/A4, and the user plane data handling processor 112 uses the compression ratio and/or content information to determine how to handle to user plane data. This forgoes the need for decompression and recompression at the user plane data handling node.

The compression ratio is calculated by comparing the number of bits before and after compression, and the content information is determined by analysing the packet using DPI. If this is performed in the compressor, then the same DPI process may be used both to determine the content information, and to perform the actual compression.

First, consider the case where the user plane data is sent together with the compression ratio and/or content information. The compression ratio and/or content information is sent as information elements within the ordinary compressed data packets. These information elements must then be detected and interpreted by the user plane data handler, and may be removed A5 by the user plane data handling node prior to the handling node forwarding the user plane data towards the destination. This prevents the receiving device from potentially misinterpreting the packets due to the extra data. An example of the information elements could be to utilise the GTP-U Private Extension Information Element (3GPP TS 29.060) as shown in FIG. 5, which is used to convey vendor specific information. Of course, if this element is added prior to compression, then the compressor should be configured to ignore the element so that it is not compressed.

The compression ratio and/or content information may be determined on a per-packet or per-session basis. If the information is determined on a per-packet basis, then one information element is associated with each packet, as shown in FIG. 6. Alternatively, one information element may be associated with multiple packets (and contain information about each of the packets). When the packets are compressed, multiple uncompressed packets may be compressed into a single compressed packet, therefore the content information may include details of each of the original packets. There may be one information element associated with each of the uncompressed packets, with each of the compressed packets, or with multiple compressed packets. If the information is associated with an uncompressed packet, it will indicate which compressed packet contains the uncompressed packet. Alternatively, the compression ratio and/or content information may be determined on a per-session basis, and there may be one information element associated with each (e.g.) TCP/UDP session. Each session carries a certain type of content, and the overall compression ratio for the session can be calculated. This approach is shown in FIG. 7.

Alternatively, the compression ratio and/or content information may be conveyed over a separate information flow, with each information element containing a reference to the packet or session to which it refers. The new information flow will need to be synchronised such that the compression ratio and/or content information arrives in time to be used to make decisions regarding the associated packets. This approach is shown in FIG. 8.

A second solution involves making a copy of the compressed user plane data in the user plane data handling node, decompressing the copy, and performing measurements, and using the results of the measurements to handle to compressed user plane data. This solution avoids having to recompress data at the user plane data handling node. An illustration of a system implementing the solution is shown in FIG. 9, and a schematic of the user plane data handler is shown in FIG. 10. A flowchart of the method of this solution is shown in FIG. 11, and apparatus suitable for implementing the solution is illustrated in FIG. 12.

A breakout handler 201 in the user plane data handling node 200 receives the user plane data, and copies B2 the user plane data to a “virtual” decompressor 202 for decompression B3. A performance measurement processor 203 then performs performance measurements B4 on the copied user plane data, such as determining the content type, bit rate, or packet loss, and the results are passed to a user plane data handling processor 204 which uses the results to determine how to handle the user plane data B5.

The breakout handler 201 may be external to the monitoring node. This may allow compatibility with legacy systems, which can be given the copied, decompressed user plane data as input, and the results from the systems can be used to determine how to handle the compressed user plane data.

The virtual decompressor in the user plane data handling node must be synchronised to match the real endpoint decompressor. This can be achieved either by monitoring all communication between the end point compressor and decompressor, in order to build up the correct compression table, or by explicitly requesting the compression table, e.g. through the O&M system, or directly from the endpoint compressor or decompressor.

An example implementation of the virtual decompressor would be to implement the decompressor on a virtual machine which emulates the end-point, helping the ensure synchronisation. However, the virtual decompressor may also be implemented as conventional software or hardware.

The decompressed, copied data may be measured by a combination of DPI and other techniques. The DPI used may be part of the virtual decompressor itself, which may also implement some monitoring functions. The content information is retrieved together with indications as to which packets and/or sessions it refers to, and is used to direct the handling of those packets and/or session, and/or to determine improvements in the handling of future packets and/or sessions. The data flow may include both compressed and uncompressed data, and the breakout handler may copy only the compressed data, or the entire data stream (with only the compressed data being decompressed).

The original traffic flow may be buffered while the copied user plane data is decompressed and analysed. The user plane data handler then takes action on the buffered packets according to the retrieved information. Alternatively, the flow may not be buffered, and the retrieved information may be used to handle future packets of the session, or stored for later analysis to determine possible network improvements. This will not ensure that the first few packets of a session are treated correctly, but will reduce the latency caused by the user plane data handler.

After the analysis has been performed, and the results acted upon and/or stored, the copied user plane data can be deleted. No further recompression is required. This approach may be deployed at multiple points in the RAN, as appropriate, for example to monitor each technology in a multi-access transmission, or each stream in a multi-path transmission.

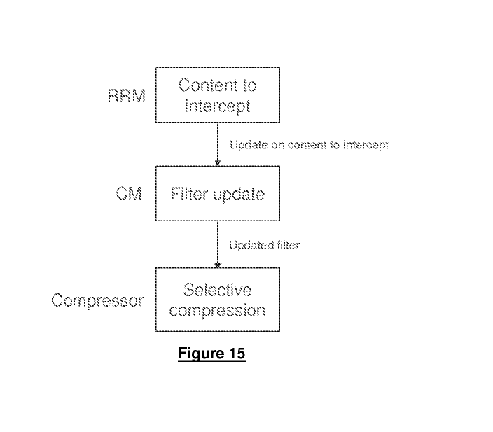

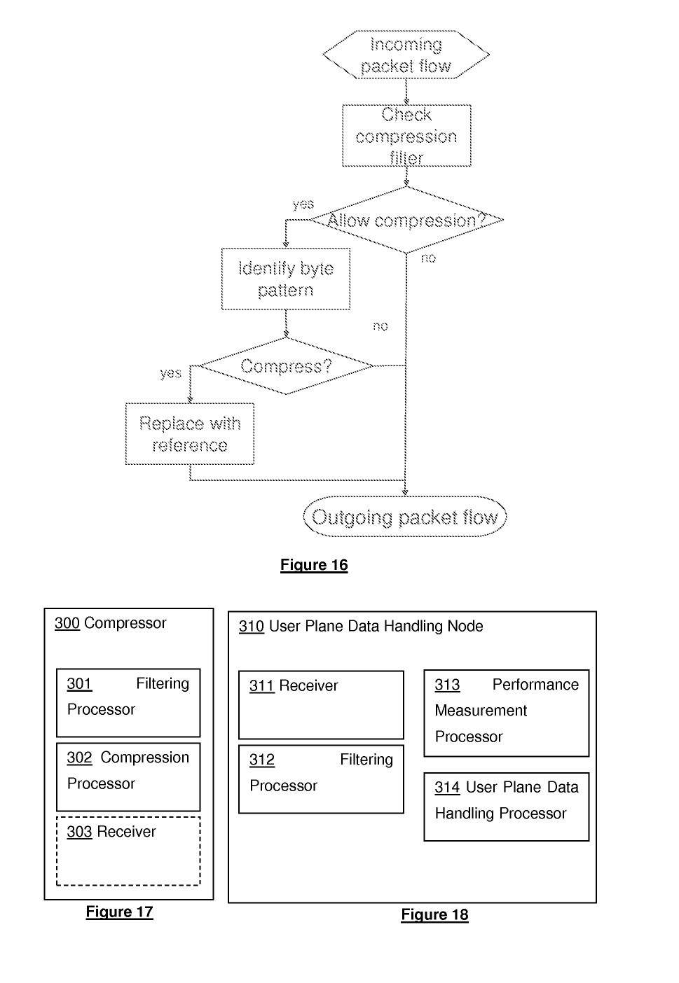

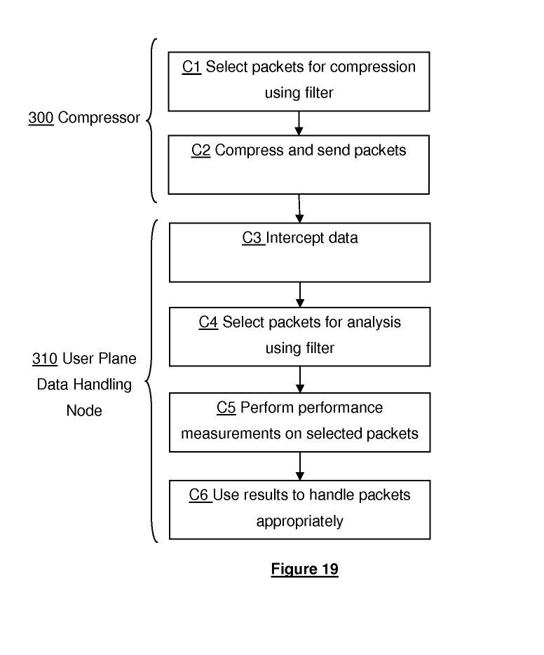

The third solution uses a dynamic filter to identify packets which are to be sent uncompressed. The user plane data handling node then examines the uncompressed packets, and handles the user plane data stream on the basis of the results from the uncompressed packets. FIGS. 13 and 14 show a system for implementing such a solution. A flowchart of the solution is shown in FIG. 15, and a more detailed flowchart of the filtering process is shown in FIG. 16. FIGS. 17 and 18 illustrate apparatus suitable for implementing the solution. FIG. 19 is a flowchart showing the overall process.

A filtering processor 301 in the compressor 300 selects which packets of the data stream should be compressed C1, and instructs the compression processor 302 to compress these packets C2. The data stream is then sent towards the receiving device. The user plane data handling node 310 receives the user plane data C3, and a filtering processor 312 in the user plane data handling node selects the packets for analysis using the same filter as the compressor C4. A performance measurement processor 313 then analyses the selected packets C5, using e.g. DPI. This will normally involve analysing the uncompressed packets, but some information about the compressed packets may also be gathered, in order to estimate the compression ratio and/or bit rate. A user plane data handling processor 314 then uses the results of the analysis to make decisions regarding handling the user plane data C6. The decompressor at the receiving endpoint also has a copy of the filter, which is used to identify the compressed packets for decompression.

The filter may be updated, either by the user plane data handling node directly sending and updated filter to the compressor, or by a central management (CM) node sending an updated filter to the user plane data handling node and the compressor. The CM node may determine the updated filter based on monitoring or bandwidth requirements, or requests from user plane data handling nodes in the network. The more packets are sent uncompressed, the greater the accuracy of the monitoring, the fewer packets are sent uncompressed, the greater the bandwidth savings in the network. Therefore, the filter may be changed regularly to balance these considerations in response to the current network situation.

The CM may be implemented as part of an existing O&M system, as a function in an existing node, or as a stand-alone node. Requests for content to intercept may be communicated to the CM from the user plane data handling nodes via proprietary or standardised interfaces, and the updated filters may likewise be transmitted to the compressor, decompressor, and user plane data handling nodes via proprietary or standardised interfaces.

1. An apparatus configured to operate as a packet inspection node, the apparatus comprising:
a data analysis processor for determining a compression ratio and/or content information for user plane data; and
a sender for sending the compression ratio and/or content information to a user plane data handling node.

2. The apparatus according to claim 1, wherein the sender is additionally configured to send the user plane data over the same channel as the compression ratio and/or content information.

3. The apparatus according to claim 1, wherein the data analysis processor is configured to determine the compression ratio and/or content information on one of a per-packet basis or a per-session basis.

4. The apparatus according to claim 1, wherein:
the apparatus comprises a compressor for compressing the user plane data; or
the sender is further configured to send the user plane data towards a compressing node.

5. The apparatus according to claim 1, wherein the data analysis processor is configured to perform deep packet inspection on the user plane data.

6. An apparatus configured to operate as a node in a radio access network, the apparatus comprising:
a content information receiver for receiving a compression ratio and/or content information associated with user plane data; and
a user plane data handling processor for handing the user plane data in dependence upon the compression ratio and/or content information.

7. The apparatus according to claim 6, wherein the content information receiver is configured to receive the user plane data over the same channel as the associated compression ratio and/or content information.

8. An apparatus configured to act as a node in a radio access network, the apparatus comprising:
a breakout handler for receiving user plane data, and copying said user plane data;
a decompressor for decompressing the copied user plane data;
a performance measurement processor for performing performance measurements on the decompressed copied user plane data; and
a user plane data handling processor for handling the user plane data in dependence upon results of the performance measurements.

9. The apparatus according to claim 8, and comprising a memory unit for storing the user plane data, wherein handling the user plane data comprises sending the stored user plane data towards a receiving device.

10. An apparatus configured to act as a compressor in a packet switched network, the apparatus comprising:
a filtering processor configured to select packets of user plane data for compression in dependence upon a compression filter;
a compression processor configured to compress the selected packets in preparation for the user plane data to be sent towards a receiving device via a user plane data handling node.

11. The apparatus according to claim 10, and comprising a receiver for receiving an update compression filter, wherein the filtering processor is configured to use the update compression filter in place of the compression filter.

12. An apparatus configured to act as a node in a radio access network, the apparatus comprising:
a receiver for receiving user plane data comprising compressed packets and uncompressed packets;
a filtering processor configured to select uncompressed packets of the user plane data for analysis in dependence upon a compression filter;
a performance measurement processor for performing performance measurements on the selected uncompressed packets of the user plane data; and
a user plane data handling processor for handling the user plane data in dependence upon results of the performance measurements.

13. A method of handling user plane data in a packet switched network, the method comprising:
at a packet inspection node:
determining a compression ratio and/or content information for the user plane data;
sending said compression ratio and/or content information towards a user plane data handling node;
at the user plane data handling node:
receiving the compression ratio and/or content information;
handling the user plane data in dependence upon the compression ratio and/or content information.

14. The method according to claim 13, wherein the compression ratio and/or content information is sent towards the data handling node over the same channel as the user plane data.

15. The method according to claim 13, wherein the packet inspection node determines the compression ratio and/or content information on one of a per-packet basis or a per-session basis.

16. The method according to claim 13, wherein the step of determining the compression ratio and/or content information for the user plane data comprises performing deep packet inspection on the user plane data.

17. A method of handling user plane data in a packet switched network, the method comprising:
at a user plane data handling node:
receiving the user plane data;
making a copy of the user plane data;
decompressing the copied user plane data;
performing performance measurements on the decompressed copied user plane data;
handling the user plane data in dependence upon results of the performance measurements.

18. The method according to claim 17, wherein the user plane data is buffered at the user plane data handling node, and the step of handling the user plane data comprises sending the buffered user plane data towards a receiving device.

19. The method according to claim 17, wherein at least part of the user plane data is sent towards a sending device prior to the step of performing performance measurements on the decompressed copied user plane data.

20. A method of handling user plane data in a packet switched network, the method comprising:
at a compressor:
selecting first packets of the user plane data for compression in dependence upon a compression filter;
compressing the first packets of the user plane data;
sending said user plane data towards a receiving device;
at a user plane data handling node:
receiving the user plane data;
selecting uncompressed second packets of the user plane data for analysis in dependence upon the compression filter;
performing performance measurements on the selected second packets of the user plane data;
handling the user plane data in dependence upon results of the performance measurements.

21. A method according to claim 20, and comprising:
at a central manager:
sending an update compression filter to the compressor;
at the compressor:
using the update compression filter in place of the compression filter.

22. A non-transitory computer readable storage medium having stored thereon a computer program which, when run on an apparatus, causes the apparatus to:
determine a compression ratio and/or content information for user plane data; and
send the compression ratio and/or content information to a user plane data handling node.

23. (canceled)
